(19) United States
(12) Patent Application Publication
(10) Pub. No.: US 2018/0253872 A1
(43) Pub. Date: Sep. 6, 2018

(54) INFORMATION PROCESSING DEVICE

(71) Applicant: FUJI XEROX CO., LTD., Tokyo (JP)

(72) Inventors: Takaaki KASHIWAGI, Kanagawa (JP); Kazutoshi YATSUDA, Kanagawa (JP); Masayasu TAKANO, Kanagawa (JP)

(73) Assignee: FUJI XEROX CO., LTD., Tokyo (JP)

(21) Appl. No.: 15/692,421

(22) Filed: Aug. 31, 2017

(30) Foreign Application Priority Data
Mar. 2, 2017 (JP) 2017-038969

(51) Int. Cl. G06T 11/20; G06T 11/00

(52) U.S. Cl. CPC G06T 11/206; G06T 11/001

(57) ABSTRACT

An information processing device includes an extraction unit and a display. The extraction unit extracts maintenance methods which have been performed for plural apparatuses or equipment and failure rates. The display displays a difference between a failure rate of a first maintenance method and a failure rate of a second maintenance method.

### CROSS-REFERENCE TO RELATED APPLICATIONS

This application is based on and claims priority under 35 USC 119 from Japanese Patent Application No. 2017-038969 filed Mar. 2, 2017.

### BACKGROUND

### Technical Field

The present invention relates to an information processing device.

### SUMMARY

According to an aspect of the invention, there is provided an information processing device including an extraction unit and a display. The extraction unit extracts maintenance methods which have been performed for plural apparatuses or equipment and failure rates. The display displays a difference between a failure rate of a first maintenance method and a failure rate of a second maintenance method.

### BRIEF DESCRIPTION OF THE DRAWINGS

Exemplary embodiments of the present invention will be described in detail based on the following figures, wherein:

FIG. 1 is a conceptual module configuration diagram of a configuration example in an exemplary embodiment of the present invention;

FIG. 2 is an explanatory diagram illustrating an example of a system configuration in an exemplary embodiment of the present invention;

FIG. 3 is an explanatory diagram illustrating an example of a data structure of an apparatus information table;

FIG. 4 is an explanatory diagram illustrating an example of a data structure of a maintenance method table;

FIG. 5 is an explanatory diagram illustrating an example of a data structure of a failure information table;

FIG. 6 is a flowchart illustrating an example of a process according to an exemplary embodiment of the present invention;

FIG. 7 is an explanatory diagram illustrating a display example in an exemplary embodiment of the present invention;

FIG. 8 is a flowchart illustrating an example of a process according to an exemplary embodiment of the present invention;

FIG. 9 is an explanatory diagram illustrating a display example in an exemplary embodiment of the present invention;

FIG. 10 is a flowchart illustrating an example of a process according to an exemplary embodiment of the present invention;

FIG. 11 is an explanatory diagram illustrating an example of a data structure of a log information table;

FIG. 12 is an explanatory diagram illustrating a display example in an exemplary embodiment of the present invention; and

FIG. 13 is a block diagram illustrating an example of a hardware configuration of a computer which implements an exemplary embodiment of the present invention.

### DETAILED DESCRIPTION

Hereinafter, exemplary embodiments of the present invention will be described with reference to the drawings.

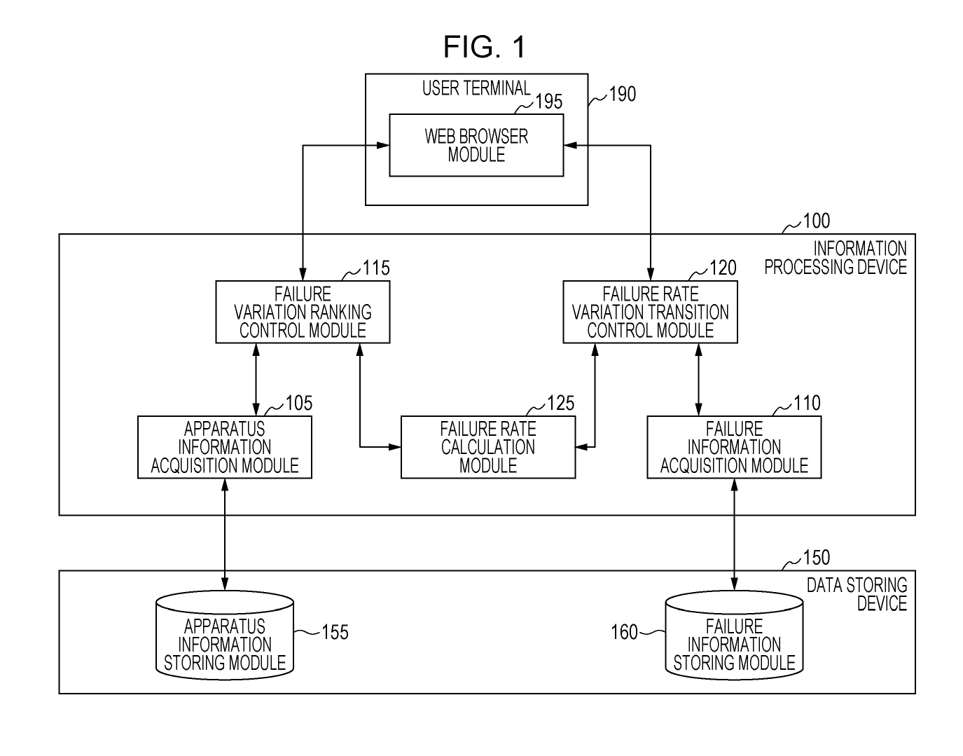

FIG. 1 is a conceptual module configuration diagram illustrating an example of a configuration according to an exemplary embodiment.

In general, the term “module” refers to a component such as software (a computer program), hardware, or the like, which may be logically separated. Therefore, a module in an exemplary embodiment refers not only to a module in a computer program but also to a module in a hardware configuration. Accordingly, through an exemplary embodiment, a computer program for causing the component to function as a module (a program for causing a computer to perform each step, a program for causing a computer to function as each unit, and a program for causing a computer to perform each function), a system, and a method are described. However, for convenience of description, the terms “store”, “cause something to store”, and other equivalent expressions will be used. When an exemplary embodiment relates to a computer program, the terms and expressions represent “causing a storing device to store”, or “controlling a storing device to store”. A module and a function may be associated on a one-to-one basis. In the actual implementation, however, one module may be implemented by one program, multiple modules may be implemented by one program, or one module may be implemented by multiple programs. Furthermore, multiple modules may be executed by one computer, or one module may be executed by multiple computers in a distributed computer environment or a parallel computer environment. Moreover, a module may include another module. In addition, hereinafter, the term “connection” may refer to logical connection (such as data transfer, instruction, and cross-reference relationship between data) as well as physical connection. The term “being predetermined” represents being set prior to target processing being performed. “Being predetermined” represents not only being set prior to processing in an exemplary embodiment but also being set even after the processing in the exemplary embodiment has started, in accordance with the condition and state at that time or in accordance with the condition and state during a period up to that time, as long as being set prior to the target processing being performed. When there are plural “predetermined values”, the values may be different from one another, or two or more values (obviously, including all the values) may be the same. The term “in the case of A, B is performed” represents “a determination as to whether it is A or not is performed, and when it is determined to be A, B is performed”, unless the determination of whether it is A or not is not required.

Moreover, a “system” or a “device” may be implemented not only by multiple computers, hardware, devices, or the like connected through a communication unit such as a network (including one-to-one communication connection), but also by a single computer, hardware, device, or the like. The terms “device” and “system” are used as synonymous terms. Obviously, the term “system” does not include social “mechanisms” (social system), which are only artificially arranged.

Furthermore, for each process in a module or for individual processes in a module performing plural processes, target information is read from a storing device and a processing result is written to the storing device after the process is performed. Therefore, the description of reading from the storing device before the process is performed or the description of writing to the storing device after the process is performed may be omitted. The storing device may be a hard disk (HD), a random access memory (RAM), an external storage medium, a storing device using a communication line, a register within a central processing unit (CPU), or the like.

An information processing device 100 according to an exemplary embodiment of the present invention is capable of displaying a maintenance method suitable for an apparatus or equipment among plural maintenance methods. As illustrated in FIG. 1, the information processing device 100 includes an apparatus information acquisition module 105, a failure information acquisition module 110, a failure variation ranking control module 115, a failure rate variation transition control module 120, and a failure rate calculation module 125. The term “maintenance” mentioned herein represents regular performance of inspections, repairs, parts replacement, and the like to achieve stable operation of an apparatus or equipment, and maintenance is performed for the purpose of avoidance and does not include repairs performed when a failure has occurred. There are plural types of maintenance methods, such as, for example, a maintenance method for not performing maintenance at all, a maintenance method for replacing principal components, and a maintenance method for replacing all components.

Maintenance is performed for apparatuses and equipment, such as, for example, office machines including a copying machine, a facsimile machine, a scanner, a printer, a multifunction device (an image processing device including two or more functions of a scanner, a printer, a copying machine, a facsimile machine, and the like), information household appliances, robots, ticket gate machines and ticket vending machines for railways, automated teller machines (ATMs) for banks, and elevators and escalators inside buildings. Simple notation such as an “apparatus” may be replaced by an “apparatus or equipment”.

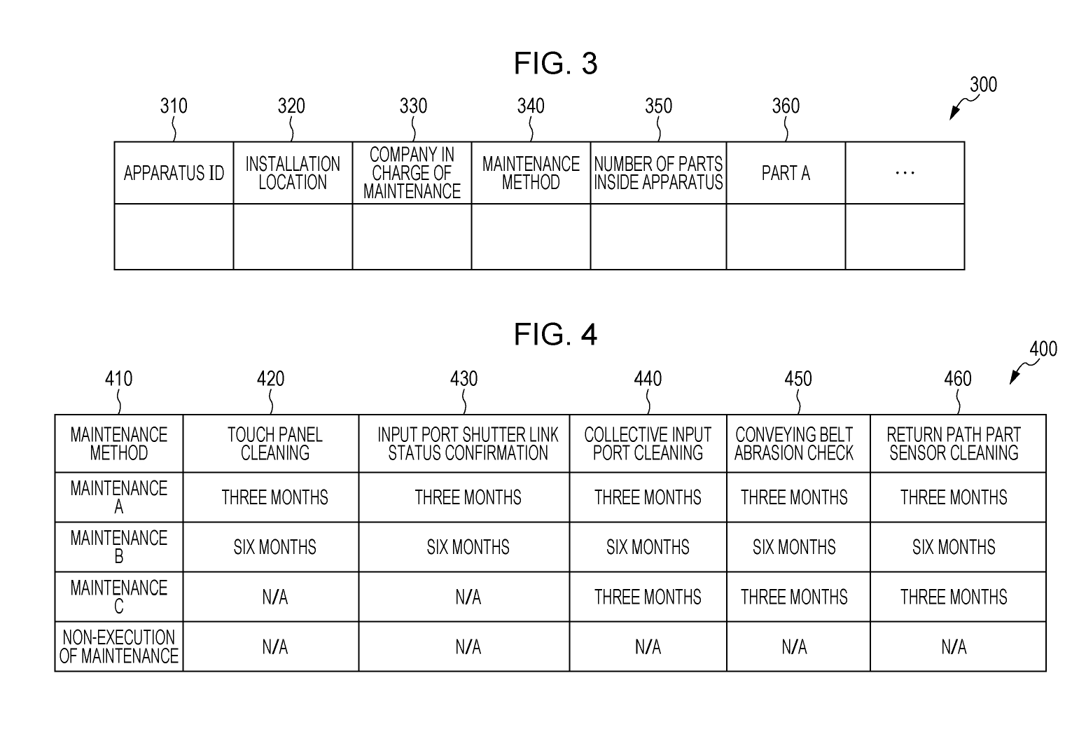

The apparatus information acquisition module 105 is connected to the failure variation ranking control module 115 and an apparatus information storing module 155 of a data storing device 150. The apparatus information acquisition module 105 extracts information regarding a target apparatus or equipment from the apparatus information storing module 155. For example, the apparatus information acquisition module 105 extracts an apparatus information table 300 and a maintenance method table 400. FIG. 3 is an explanatory diagram illustrating an example of a data structure of the apparatus information table 300. The apparatus information table 300 includes an apparatus identification (ID) field 310, an installation location field 320, a company-in-charge-of-maintenance field 330, a maintenance method field 340, a number-of-parts-inside-apparatus field 350, a part A field 360, and the like. In this exemplary embodiment, the apparatus ID field 310 stores information for uniquely identifying an apparatus (apparatus ID). The installation location field 320 stores an installation location of the apparatus. The company-in-charge-of-maintenance field 330 stores a company in charge of maintenance of the apparatus. The maintenance method field 340 stores a maintenance method for the apparatus. The number-of-parts-inside-apparatus field 350 stores the number of parts inside the apparatus. The part A field 360 stores part A. The number of part A fields 360 corresponds to the number indicated in the number-of-parts-inside-apparatus field 350. The term “part” mentioned herein corresponds to a unit for repair and may be regarded as a component.

FIG. 4 is an explanatory diagram illustrating an example of a data structure of the maintenance method table 400. The maintenance method table 400 includes a maintenance method field 410, a touch panel cleaning field 420, an input port shutter link status confirmation field 430, a collective input port cleaning field 440, a conveying belt abrasion check field 450, and a return path part sensor cleaning field 460. The maintenance method field 410 stores a maintenance method. The touch panel cleaning field 420 stores the frequency of cleaning of a touch panel. The input port shutter link status confirmation field 430 stores the frequency of confirmation of the status of an input port shutter link. The collective input port cleaning field 440 stores the frequency of cleaning inside a collective input port. The conveying belt abrasion check field 450 stores the frequency of checking for abrasion of a conveying belt. The return path part sensor cleaning field 460 stores the frequency of cleaning of a return path part sensor.

The touch panel cleaning field 420, the input port shutter link status confirmation field 430, the collective input port cleaning field 440, the conveying belt abrasion check field 450, and the return path part sensor cleaning field 460 indicate specific execution details of maintenance. For example, a maintenance method “maintenance A” represents that cleaning of a touch panel is performed once every three months, confirmation for the status of an input port shutter link is performed once every three months, cleaning inside a collective input port is performed once every three months, checking for abrasion of a conveying belt is performed once every three months, and cleaning of a return path part sensor is performed once every three months. Furthermore, a maintenance method “non-execution of maintenance” represents that maintenance is not performed at all.

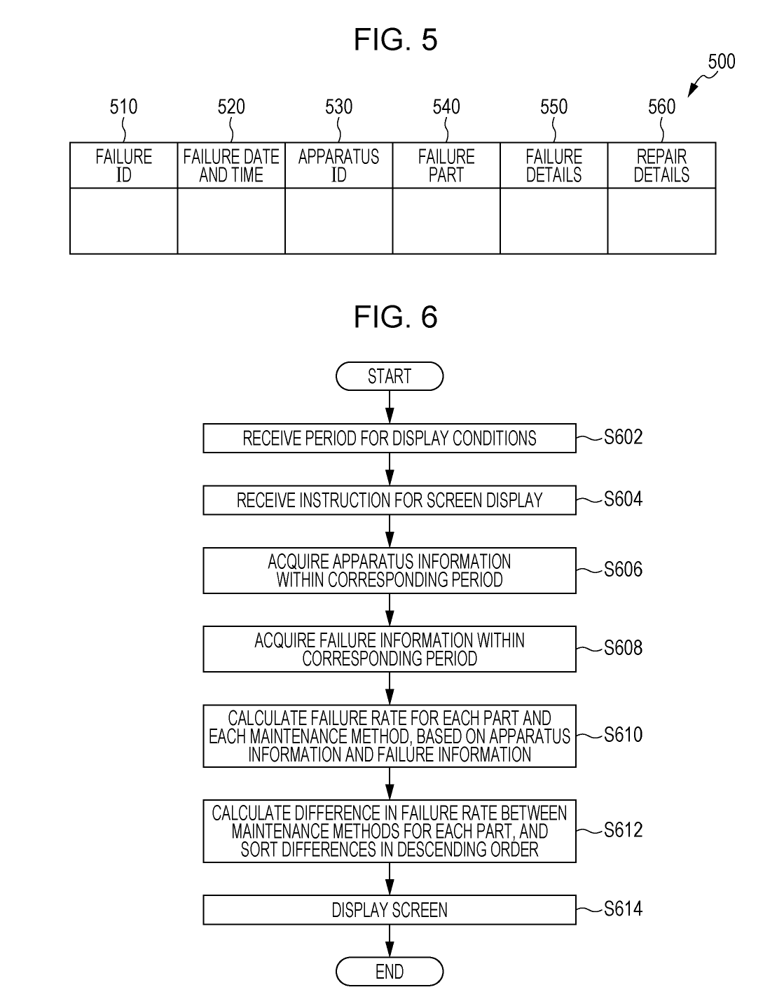

The failure information acquisition module 110 is connected to the failure rate variation transition control module 120 and a failure information storing module 160 of the data storing device 150. The failure information acquisition module 110 extracts information of a failure which has occurred at a target apparatus or equipment and a repair which has performed for the failure. For example, the failure information acquisition module 110 extracts a failure information table 500. FIG. 5 is an explanatory diagram illustrating an example of a data structure of the failure information table 500. The failure information table 500 stores history information regarding failures and repairs. The failure information table 500 includes a failure ID field 510, a failure date and time field 520, an apparatus ID field 530, a failure part field 540, a failure details field 550, and a repair details field 560. In this exemplary embodiment, the failure ID field 510 stores information for uniquely identifying a failure (failure ID). The failure date and time field 520 stores a failure date and time. The apparatus ID field 530 stores an apparatus ID of an apparatus at which the failure has occurred. The failure part field 540 stores a failure part. The failure details field 550 stores the failure details. The repair details field 560 stores the repair details.

The failure variation ranking control module 115 is connected to the apparatus information acquisition module 105, the failure rate calculation module 125, and a Web browser module 195 of a user terminal 190. The failure variation ranking control module 115 displays the number of failures which have occurred at an apparatus or equipment and variations in the failure rate that are ranked according to the maintenance method. Specifically, the failure variation ranking control module 115 generates a Web page on the Web browser module 195 that the failure variation ranking control module 115 accesses, and provides the Web page.

The failure rate variation transition control module 120 is connected to the failure information acquisition module 110, the failure rate calculation module 125, and the Web browser module 195 of the user terminal 190. The failure rate variation transition control module 120 displays a difference between the failure rate of a first maintenance method and the failure rate of a second maintenance method. Specifically, the failure rate variation transition control module 120 generates a Web page on the Web browser module 195 and provides the Web page.

Furthermore, the failure rate variation transition control module 120 may display time-series differences of failure rate.

Furthermore, the failure rate variation transition control module 120 may graphically display the time-series differences of failure rate.

Furthermore, the failure rate variation transition control module 120 may display a difference of failure rate for each part of an apparatus or equipment.

Furthermore, the failure rate variation transition control module 120 may provide display according to the order of differences of failure rate.

Furthermore, the failure rate variation transition control module 120 may display a difference of failure rate for each categorization of an apparatus or equipment.

Furthermore, the failure rate variation transition control module 120 may provide display according to the order of differences of failure rate.

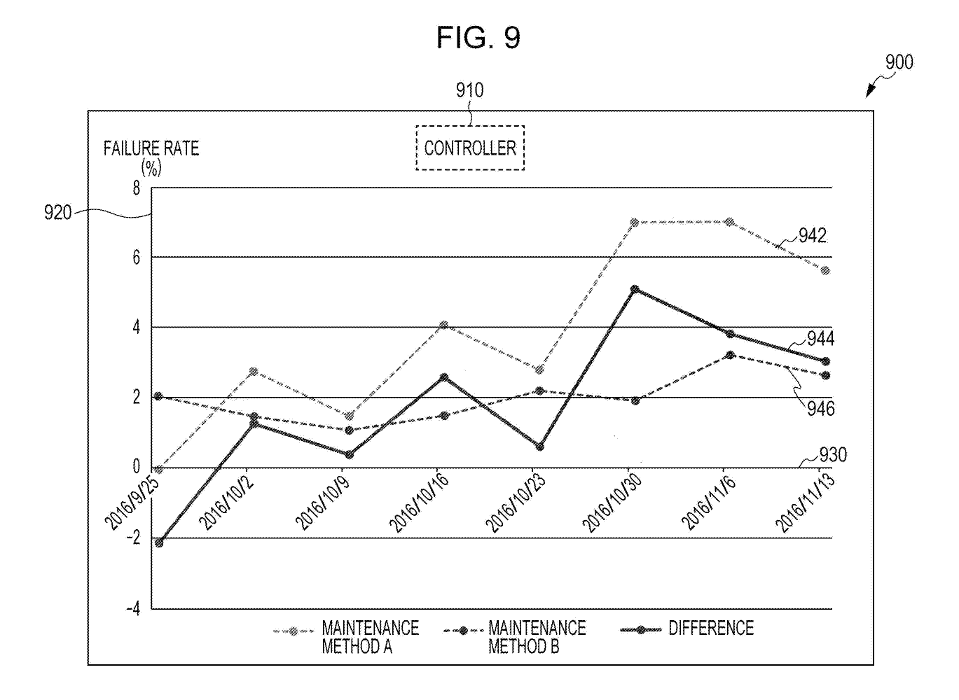

Furthermore, in the case where the failure rate of the first maintenance method is higher than the failure rate of the second maintenance method by a predetermined value or more, the failure rate variation transition control module 120 may highlight the second maintenance method, for example, with a so-called “recommend function”. For example, with the recommend function, a maintenance method with a low failure rate is suggested. For highlighting, for example, as illustrated in FIG. 9, a line graph indicating a maintenance method B may be displayed in a different color, in bold, in blinking, or the like so that the line graph indicating the maintenance method B stands out compared to a line graph indicating a maintenance method A.

Furthermore, in the case where the increase rate of the failure rate of the first maintenance method is higher than the increase rate of the failure rate of the second maintenance method by a predetermined value or more, the failure rate variation transition control module 120 may highlight the second maintenance method, for example, with a so-called “recommend function”. For example, as illustrated in FIG. 9, if the line graph indicating the failure rate of the maintenance method A rises to the right compared to the line graph indicating the failure rate of the maintenance method B, the maintenance method B is suggested.

Furthermore, in the case where a difference in the failure rate is less than or equal to a predetermined value, the failure rate variation transition control module 120 may highlight, among the first maintenance method and the second maintenance method, a maintenance method with a less cost, a lower frequency of maintenance, a less number of maintenance target items, or a shorter operation time. That is, in the case where a difference in the failure rate is less than or equal to the predetermined value, the failure rate variation transition control module 120 may highlight, among the first maintenance method and the second maintenance method, a maintenance method with a less cost, a lower frequency of maintenance, a less number of maintenance target items, or a shorter operation time, for example, with a so-called “recommend function”. For example, if there is not much difference in the failure rate, a maintenance method with a less cost is suggested. The predetermined value (threshold) mentioned herein may be a value determined in advance. Alternatively, based on a comparison of costs (operation time and replacement cost within a predetermined period of time), a small threshold may be used for the case where a difference in the cost is large, and a large threshold may be used for the case where a difference in the cost is small.

The failure rate calculation module 125 is connected to the failure variation ranking control module 115 and the failure rate variation transition control module 120. The failure rate calculation module 125 extracts maintenance methods which have been performed for plural apparatuses or equipment and failure rates. Specifically, the failure rate calculation module 125 extracts a maintenance method corresponding to an apparatus ID (apparatus ID field 310) from the maintenance method field 340 of the apparatus information table 300, and calculates the failure rate of the apparatus. The failure rate may be counted, by referring to the failure information table 500, the number of failure times of the apparatus within a predetermined period (a specific period within an equation, for example, one week, one month, etc.).

The failure rate may be calculated using, for example, the following equation:

Failure rate=(the number of occurrences of failure within a specific period/the number of operating target apparatuses)×(30/the number of days within the specific period)

In the above equation, “30” is used so that the failure rate for one month is obtained.

For example, in the case where the specific period is set to one week, the following equation is used:

Failure rate=(the number of occurrences of failure within one week/the number of operating apparatuses within one week)×(30/7)

The data storing device 150 includes the apparatus information storing module 155 and the failure information storing module 160. The data storing device 150 collects, from plural apparatuses or equipment, information regarding a maintenance method, information regarding a failure, information regarding a repair, and the like, and stores the acquired information.

The apparatus information storing module 155 is connected to the apparatus information acquisition module 105 of the information processing device 100. The apparatus information storing module 155 stores, for example, information containing the apparatus information table 300 and information containing the maintenance method table 400.

The failure information storing module 160 is connected to the failure information acquisition module 110 of the information processing device 100. The failure information storing module 160 stores, for example, information containing the failure information table 500.

The user terminal 190 includes the Web browser module 195. The user terminal 190 is a terminal which may be used by a user, and a personal computer, a notebook personal computer, a portable terminal, or the like corresponds to the user terminal 190.

The Web browser module 195 is connected to the failure variation ranking control module 115 and the failure rate variation transition control module 120 of the information processing device 100. The Web browser module 195 provides display to a user, in accordance with a display instruction from the failure variation ranking control module 115 and the failure rate variation transition control module 120. Specifically, the Web browser module 195 displays a Web page provided by the failure variation ranking control module 115 and the failure rate variation transition control module 120.

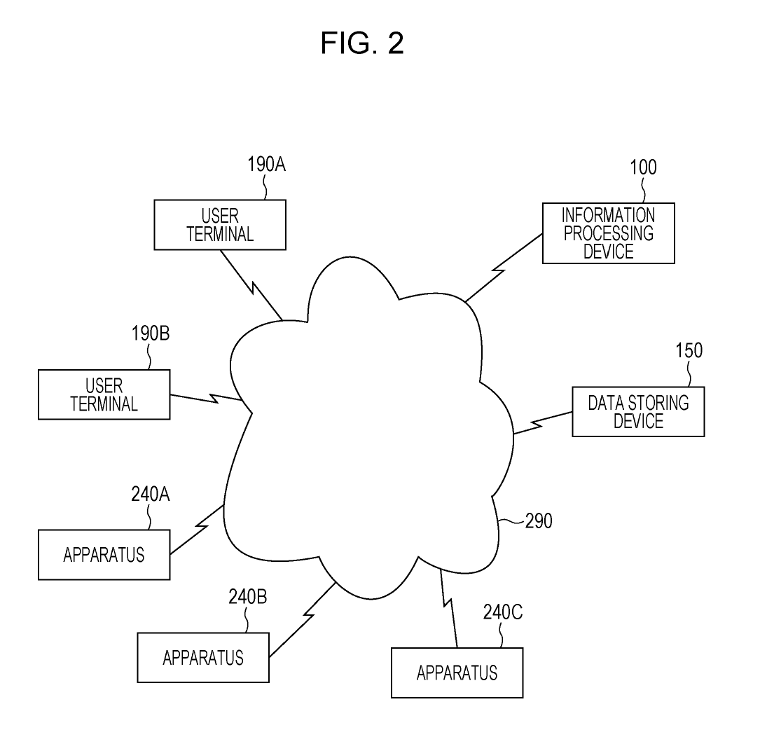

FIG. 2 is an explanatory diagram illustrating an example of a system configuration in an exemplary embodiment.

The information processing device 100, the data storing device 150, a user terminal 190A, a user terminal 190B, an apparatus 240A, an apparatus 240B, and an apparatus 240C are connected with one another via a communication line 290. The communication line 290 may be provided in a wireless or wireless manner or in the form of combination of a wired and wireless manner. The communication line 290 may be, for example, the Internet, an intranet, or the like as a communication infrastructure. Furthermore, functions by the information processing device 100 may be implemented as a cloud service.

The data storing device 150 collects information of maintenance methods, failure histories, and the like from the plural apparatuses 240, and stores the acquired information. The information processing device 100 generates graph display of a difference in the failure rate between maintenance methods and the like, and causes the user terminal 190 to display the generated graph. A user browses the display on the user terminal 190, and examines a maintenance method (specifically, selects a maintenance method suitable for an apparatus or a device).

Specifically, display is provided as described below.

The information processing device 100 may cause the user terminal 190 to display a difference in the failure rate between maintenance methods for each part. Accordingly, a user is able to determine superiority or inferiority of the individual maintenance methods.

Furthermore, by displaying time-series differences in the failure rate, superiority or inferiority may be confirmed quickly, and it may be determined whether or not the superiority or inferiority are only temporary.

A difference in the failure rate between maintenance methods is displayed. Accordingly, superiority or inferiority of the maintenance methods may be confirmed.

A graph indicating time-series differences in the failure rate between maintenance methods is displayed. Accordingly, it may be determined, in accordance with how the graph settles down, whether or not superiority or inferiority is only temporary.

Ranking of differences in the failure rate between maintenance methods is displayed in a descending order. Accordingly, it may be determined which part is largely affected by a change of a maintenance method.

By categorizing apparatuses (for example, according to the use frequency), a difference in the failure rate is displayed for each categorization. Accordingly, superiority of inferiority of maintenance methods may be determined for each category.

As described above, the user terminal 190 may be an office machine, an information household appliance, a robot, a ticket gate machine or ticket vending machine for railways, an automated teller machine (ATM) for banks, an elevator or escalator inside buildings, or the like. Many of these apparatuses or equipment require regular maintenance, and high cost is required for maintenance.

In contrast, it is difficult to determine criteria for “how often and which part of an apparatus is to undergo maintenance”, and determining an appropriate method of maintenance (maintenance method) may reduce the cost required for maintenance.

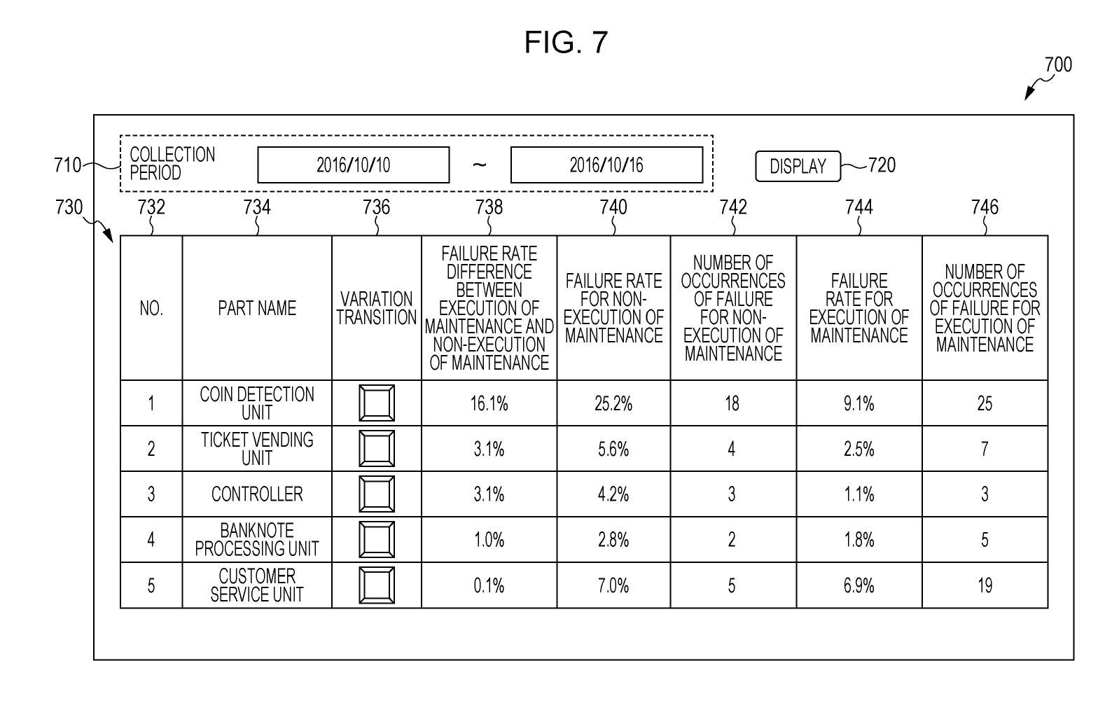

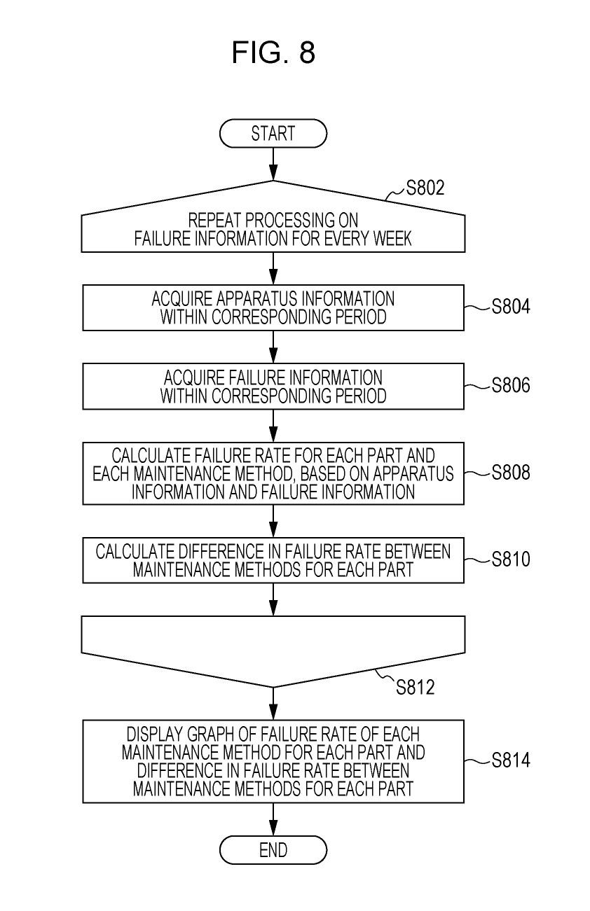

Thus, the information processing device 100 performs the processes illustrated in FIGS. 6, 8, and the like and causes the user terminal 190 to provide the display illustrated in FIGS. 7. 9, and the like.

FIG. 6 is a flowchart illustrating an example of a process according to an exemplary embodiment. Specifically, FIG. 6 illustrates an example of a process for displaying failure variation ranking.

In step S602, a period for display conditions is received. For example, a period is specified by a user operation.

In step S604, an instruction for screen display is received. For example, an instruction for screen display is issued by a user operation.

In step S606, apparatus information within the corresponding period is acquired. For example, information of a target apparatus within the corresponding period is extracted from the apparatus information table 300 and the maintenance method table 400.

In step S608, failure information within the corresponding period is acquired. For example, information regarding a failure in the target apparatus within the corresponding period is extracted from the failure information table 500.

In step S610, failure rate is calculated for each part and each maintenance method, based on the apparatus information and the failure information. For example, the failure rate for each part of the target apparatus within the corresponding period and the failure rate for each maintenance method within the corresponding period are calculated, based on the failure date and time field 520 of the failure information table 500.

In step S612, a difference in the failure rate between maintenance methods is calculated for each part, and the differences are sorted in a descending order. For example, a difference in the failure rate between maintenance methods as comparison targets is calculated for each part.

In step S614, screen display is performed. For example, a screen 700 illustrated in FIG. 7 is displayed.

FIG. 7 is an explanatory diagram illustrating a display example in an exemplary embodiment.

On the screen 700, a period reception region 710, a display button 720, and a failure rate variation ranking display region 730 are displayed. The screen 700 is an example of a screen for confirming a difference in failure rate between the case where maintenance is performed (for example, all parts undergo maintenance once every three months) and the case where no maintenance is performed.

In the period reception region 710, a period specified by a user operation is received. The beginning of a period (in the example of FIG. 7, “2016/10/10”) and the ending of the period (in the example of FIG. 7, “2016/10/16”) are input. Accordingly, the processing of step S602 is performed.

Then, the display button 720 is selected in accordance with a user operation. Accordingly, the processing of step S604 is performed.

In the failure rate variation ranking display region 730, a No. field 732, a part name field 734, a variation transition field 736, a failure rate difference between execution of maintenance and non-execution of maintenance field 738, a failure rate for non-execution of maintenance field 740, a number of occurrences of failure for non-execution of maintenance field 742, a failure rate for execution of maintenance field 744, and a number of occurrences of failure for execution of maintenance field 746 are displayed. A number is displayed in the No. field 732. The name of a part is displayed in the part name field 734. A button for displaying a failure rate variation transition screen for each part is displayed in the variation transition field 736. When the variation transition field 736 is selected, the process illustrated in FIG. 8 is performed. In the failure rate difference between execution of maintenance and non-execution of maintenance field 738, a difference obtained by subtracting the failure rate for “execution of maintenance” (failure rate for execution of maintenance field 744) from the failure rate for “non-execution of maintenance” (failure rate for non-execution of maintenance field 740) is displayed. For example, for the No. field 732 of “1”, “16.1” is obtained by subtracting “9.1” from “25.2”. For the No. field 732 of “5”, “0.1” is obtained by subtracting “6.9” from “7.0”. In the failure rate for non-execution of maintenance field 740, a failure rate for a maintenance method “non-execution of maintenance” is displayed. In the number of occurrences of failure for non-execution of maintenance field 742, the number of occurrences of failure for the maintenance method “non-execution of maintenance” is displayed. In the failure rate for execution of maintenance field 744, a failure rate for a maintenance method “execution of maintenance” is displayed. In the number of occurrences of failure for execution of maintenance field 746, the number of occurrences of failure for the maintenance method “execution of maintenance” is displayed.

In the failure rate variation ranking display region 730 in the example illustrated in FIG. 7, “maintenance A” (in the example of FIG. 7, “execution of maintenance”) and “non-execution of maintenance” in the maintenance method table 400 illustrated in FIG. 4 are compared with each other.

In the processing from steps S606 to S614, items in the failure rate variation ranking display region 730 are displayed. In particular, values in the failure rate for non-execution of maintenance field 740 and the failure rate for execution of maintenance field 744 are calculated by the processing of step S610, values in the failure rate difference between execution of maintenance and non-execution of maintenance field 738 are calculated by the processing of step S612, and the values are sorted in a descending order (from the largest value to the smallest value). With this sorting, ranking corresponds to the No. field 732. That is, based on comparison between the maintenance method “execution of maintenance” and the maintenance method “non-execution of maintenance”, parts affected by “execution of maintenance” are displayed in an order.

FIG. 8 is a flowchart illustrating an example of a process according to an exemplary embodiment. Specifically, FIG. 8 illustrates an example of a process for displaying transition of variations in the failure rate.

In step S802, processing up to step S812 is performed on failure information in a repeated manner for every week. Obviously, “every week” is merely an example, and the processing may be performed for a different period (for example, every other week, every ten days, every month, or the like).

In step S804, apparatus information within the corresponding period is acquired.

In step S806, failure information within the corresponding period is acquired.

In step S808, a failure rate is calculated for each part and each maintenance method, based on the apparatus information and the failure information.

In step S810, a difference in the failure rate between maintenance methods is calculated for each part.

In step S812, the processing from step S802 is performed in a repeated manner.

In step S814, a failure rate for each maintenance method and a difference in the failure rate between maintenance methods are displayed in a graph for each part. For example, a screen 900 illustrated in FIG. 9 is displayed.

FIG. 9 is an explanatory diagram illustrating a display example in an exemplary embodiment.

On the screen 900, a target part display region 910, a vertical axis (failure rate (%)) 920, and a horizontal axis (date) 930 are displayed, and a graph of maintenance method A: 942, a graph of maintenance method B: 946, and a graph of difference 944 are displayed. These graphs are examples of a graph indicating failure rate variation transition.

The graphs indicate failure rate variation transition in a part “controller” by the target part display region 910. The horizontal axis represents time, and the vertical axis represents failure rate. In the processing of step S808, the maintenance method A: 942 and the maintenance method B: 946 are plotted.

In the processing of step S810, the difference 944 is plotted. The difference 944 represents a difference in the failure rate between comparison targets (specifically, “failure rate of the maintenance method A: 942”−“failure rate of the maintenance method B: 946”). Thus, by referring to the difference 944, a difference in the failure rate between the maintenance methods may be confirmed for each week.

In the example of FIG. 9, the failure rate of the maintenance method A: 942 is higher than the failure rate of the maintenance method B: 946, and the difference 944 rises to the right. Therefore, it is clear that maintenance in the maintenance method B: 946 is more appropriate than maintenance in the maintenance method A: 942. When the difference 944 indicates a value close to a failure rate of 0%, there is no difference in the failure rate. Therefore, it is clear that any of the maintenance methods may be adopted. In general, a maintenance method with a low cost is selected.

Furthermore, when the difference 944 indicates a predetermined value or more (the failure rate of the maintenance method A: 942 is higher than the failure rate of the maintenance method B: 946 by a predetermined value or more), the maintenance method B: 946 may be highlighted.

Furthermore, when the difference 944 indicates the predetermined value or less, a maintenance method, among the maintenance method A: 942 and the maintenance method B: 946 as comparison targets, with a less cost, a lower frequency of maintenance, a less number of maintenance target items, or a shorter operation time may be highlighted.

In the example of FIG. 9, an example of a failure rate is indicated on the vertical axis. However, the vertical axis represents an increase rate of failure rate (for example, the increase rate of failure rate for this week to failure rate for the last week). In addition to a graph of the increase rates of failure rate of maintenance methods as comparison targets, a graph indicating a difference in the increase rate of failure rate between the maintenance methods may be displayed. In this case, when the difference in the increase rate of failure rate is equal to or more than a predetermined value (the increase rate of failure rate of one maintenance method is higher than the increase rate of failure rate of the other maintenance method by a predetermined value or more), a maintenance method with a lower increase rate may be highlighted.

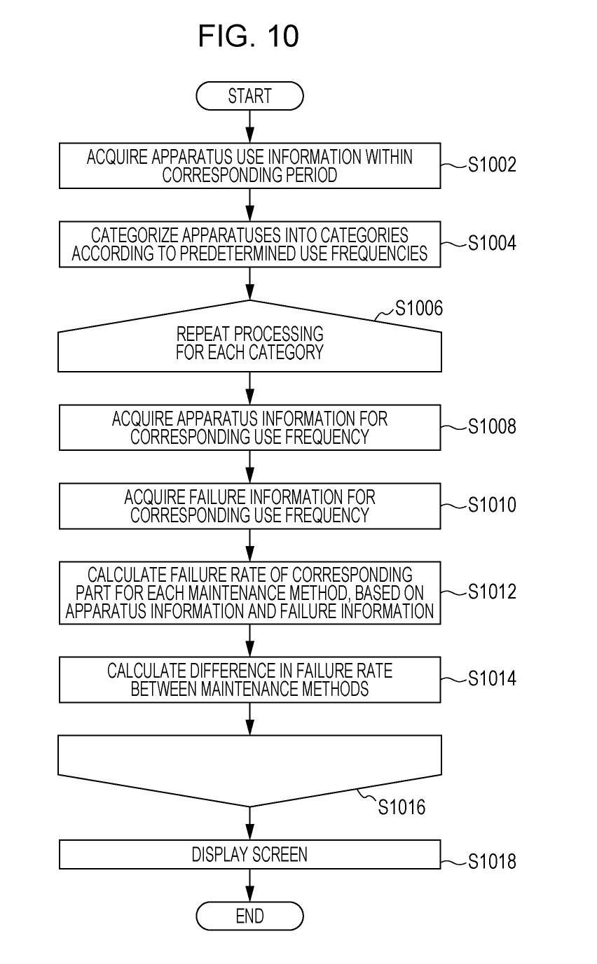

FIG. 10 is a flowchart illustrating an example of a process according to an exemplary embodiment. Specifically, an example of a process for displaying failure rate variations for each use frequency is illustrated. In this example, categorization by a use frequency is illustrated. However, categorization by other indices (the size of an apparatus, the price of the apparatus, etc.) may be performed.

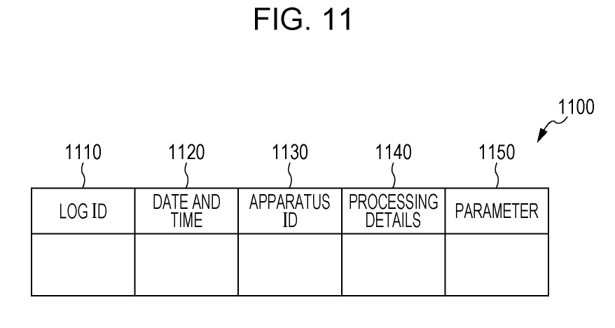

In step S1002, apparatus use information within a corresponding period is acquired. For example, a log information table 1100 which is stored in the apparatus information storing module 155 is acquired. FIG. 11 is an explanatory diagram illustrating an example of a data structure of the log information table 1100. The log information table 1100 is acquired by the individual apparatuses 240, and is stored in the apparatus information storing module 155.

The log information table 1100 includes a log ID field 1110, a date and time field 1120, an apparatus ID field 1130, a processing details field 1140, and a parameter field 1150. In this exemplary embodiment, the log ID field 1110 stores information (log ID) for uniquely identifying a log. The date and time field 1120 stores date and time. The apparatus ID field 1130 stores an apparatus ID. The processing details field 1140 stores the details of processing which was performed at the date and time. The parameter field 1150 stores a parameter used in the processing details. For example, by counting the number of rows in which predetermined processing is indicated within the processing details field 1140 (processing details indicating use of the apparatus), the number of use times may be calculated.

In step S1004, apparatuses are categorized according to use frequency set in advance.

In step S1006, processing up to step S1016 is performed in a repeated manner for each categorization.

In step S1008, apparatus information for the corresponding use frequency is acquired.

In step S1010, failure information for the corresponding use frequency is acquired.

In step S1012, the failure rate of a corresponding part is calculated for each maintenance method, based on the apparatus information and the failure information.

In step S1014, a difference in the failure rate between maintenance methods is calculated.

In step S1016, processing from step S1006 is performed in a repeated manner.

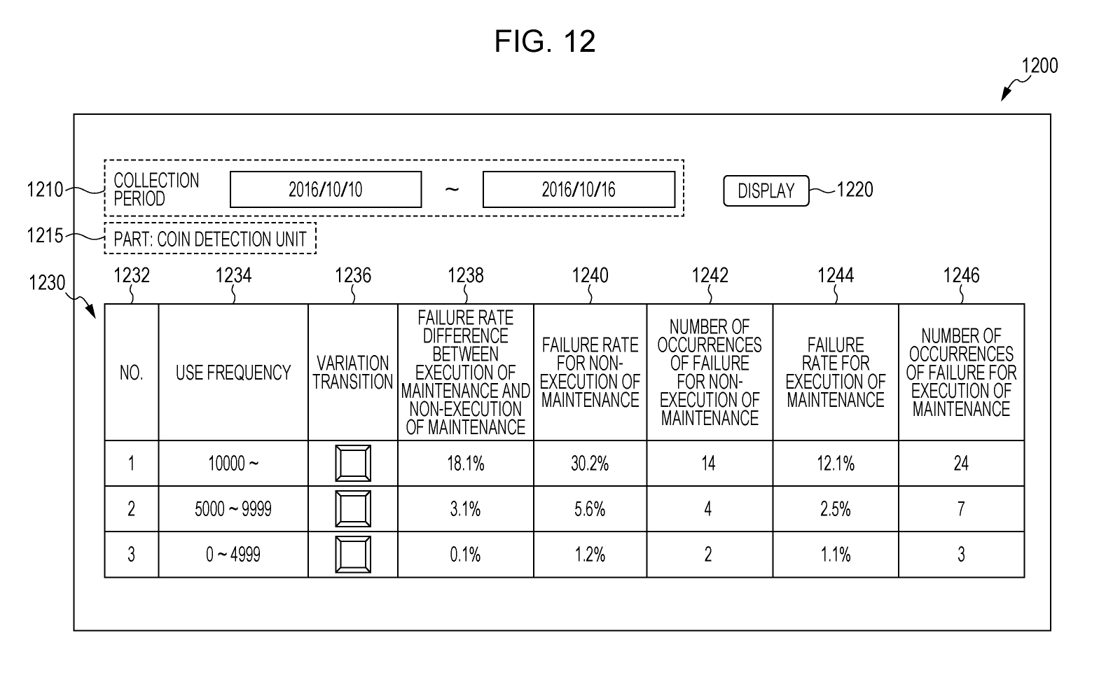

In step S1018, screen display is performed. For example, a screen 1200 illustrated in FIG. 12 is displayed.

FIG. 12 is an explanatory diagram illustrating a display example in an exemplary embodiment.

On the screen 1200, a period reception region 1210, a part display region 1215, a display button 1220, and a failure rate variation for each use frequency display region 1230 are displayed. The screen 1200 is an example of a screen for displaying variations in the failure rate for each use frequency category. Specifically, a difference in the failure rate of a coin detection unit among an apparatus which is used 10,000 or more times a day, an apparatus which is used 5,000 or more and 9,999 or less times a day, and an apparatus which is used 4,999 or less times a day is displayed.

In the failure rate variation for each use frequency display region 1230, a No. field 1232, a use frequency field 1234, a variation transition field 1236, a failure rate difference between execution of maintenance and non-execution of maintenance field 1238, a failure rate for non-execution of maintenance field 1240, a number of occurrences of failure for non-execution of maintenance field 1242, a failure rate for execution of maintenance field 1244, and a number of occurrences of failure for execution of maintenance field 1246 are displayed. In the No. field 1232, a number is displayed. In the use frequency field 1234, a use frequency is displayed. In the variation transition field 1236, a button for a screen for displaying the failure rate transition for each use frequency is displayed. In failure rate difference between execution of maintenance and non-execution of maintenance field 1238, a difference obtained by subtracting the failure rate for “execution of maintenance” (failure rate for execution of maintenance field 1244) from the failure rate for “non-execution of maintenance” (failure rate for non-execution of maintenance field 1240) is displayed. In the failure rate for non-execution of maintenance field 1240, the failure rate for the case where maintenance is not performed is displayed. In the number of occurrences of failure for non-execution of maintenance field 1242, the number of occurrences of failure for the case where maintenance is not performed is displayed. In the failure rate for execution of maintenance field 1244, the failure rate for the case where maintenance is performed is displayed. In the number of occurrences of failure for execution of maintenance field 1246, the number of occurrences of failure for the case where maintenance is performed is displayed.

By browsing the screen 1200, the user is able to understand that maintenance may not need to be performed for an apparatus which is used 4,999 or less times a day.

Obviously, by using information within the failure rate variation for each use frequency display region 1230, graph display illustrated in FIG. 9 may be provided.

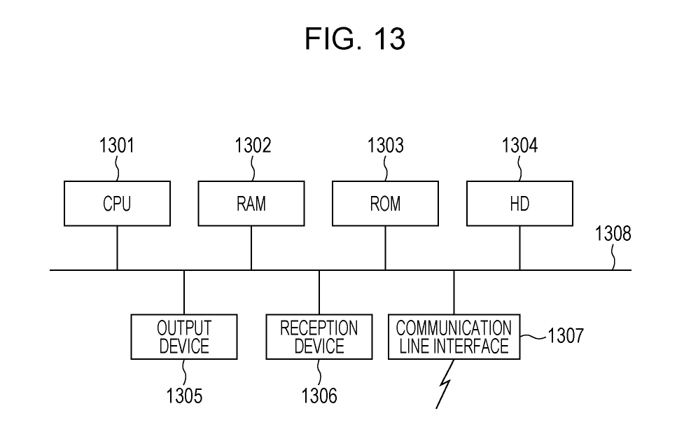

A hardware configuration of a computer which executes a program according to an exemplary embodiment is, as illustrated in FIG. 13, a general computer, and specifically, a computer or the like which may serve as a personal computer or a server. That is, as a specific example, a CPU 1301 is used as a processing unit (arithmetic unit), and a RAM 1302, a read only memory (ROM) 1303, and an HD 1304 are used as a storing device. For example, a hard disk or a solid state drive (SSD) may be used as the HD 1304. The hardware configuration includes the CPU 1301 which executes a program such as the apparatus information acquisition module 105, the failure information acquisition module 110, the failure variation ranking control module 115, the failure rate variation transition control module 120, the failure rate calculation module 125, the Web browser module 195, and the like, the RAM 1302 which stores the program and data, the ROM 1303 which stores a program or the like for activating the computer, the HD 1304, which is an auxiliary storing device (may be a flash memory or the like) which includes functions as the apparatus information storing module 155 and the failure information storing module 160, a reception device 1306 which receives data in accordance with an operation performed by a user to a keyboard, a mouse, a touch screen, a microphone, or the like, an output device 1305 such as a cathode ray tube (CRT), a liquid crystal display, or a speaker, a communication line interface 1307 for allowing connection with a communication network such as a network interface card, and a bus 1308 for allowing data exchange among the above units. Multiple computers having the above configuration may be connected to one another via a network.

The foregoing exemplary embodiment that relates to a computer program is implemented by causing a system of the above hardware configuration to read the computer program, which is software, in cooperation of software and hardware resources.

The hardware configuration illustrated in FIG. 13 illustrates a configuration example. An exemplary embodiment is not limited to the configuration illustrated in FIG. 13 as long as a configuration which may execute modules explained in the exemplary embodiment is provided. For example, part of the modules may be configured as dedicated hardware (for example, an application specific integrated circuit (ASIC) or the like), part of the modules may be arranged in an external system in such a manner that they are connected via a communication line, or the system illustrated in FIG. 13 which is provided in plural may be connected via a communication line in such a manner that they operate in cooperation. Furthermore, in particular, part of the modules may be incorporated in a personal computer, a portable information communication device (including a mobile phone, a smart phone, a mobile device, and a wearable computer), an information electronic appliance, a robot, a copying machine, a facsimile machine, a scanner, a printer, or a multifunction device (an image processing device having two or more functions of a scanner, a printer, a copying machine, a facsimile machine, and the like).

The programs described above may be stored in a recording medium and provided or may be supplied through communication. In this case, for example, the program described above may be considered as an invention of “a computer-readable recording medium which records a program”.

“A computer-readable recording medium which records a program” represents a computer-readable recording medium which records a program to be used for installation, execution, and distribution of the program.

A recording medium is, for example, a digital versatile disc (DVD), including “a DVD-R, a DVD-RW, a DVD-RAM, etc.”, which are the standards set by a DVD forum, and “a DVD+R, a DVD+RW, etc.”, which are the standards set by a DVD+RW, a compact disc (CD), including a read-only memory (CD-ROM), a CD recordable (CD-R), a CD rewritable (CD-RW), etc., a Blu-ray™ Disc, a magneto-optical disk (MO), a flexible disk (FD), a magnetic tape, a hard disk, a ROM, an electrically erasable programmable read-only memory (EEPROM™), a flash memory, a RAM, a secure digital (SD) memory card, or the like.

The entire or part of the above-mentioned program may be recorded in the above recording medium, to be stored and distributed. Furthermore, the program may be transmitted through communication, for example, a wired network or a wireless communication network used for a local area network (LAN), a metropolitan area network (MAN), a wide area network (WAN), the Internet, an intranet, an extranet, or the like, or a transmission medium of a combination of the above networks. Alternatively, the program or a part of the program may be delivered by carrier waves.

The above-mentioned program may be the entire or part of another program or may be recorded in a recording medium along with a separate program. Further, the program may be divided into multiple recording media and recorded. The program may be recorded in any format, such as compression or encryption, as long as the program may be reproduced.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
an extraction unit that extracts maintenance methods which have been performed for a plurality of apparatuses or equipment and failure rates; and
a display that displays a difference between a failure rate of a first maintenance method and a failure rate of a second maintenance method.

2. The information processing device according to claim 1,
wherein the display displays the difference in the failure rate in a time-series manner.

3. The information processing device according to claim 2,
wherein the display graphically displays the difference in the failure rate.

4. The information processing device according to claim 1,
wherein the display displays a difference in the failure rate between the apparatuses or equipment for each part of the apparatuses or equipment.

5. The information processing device according to claim 4,
wherein the display provides display in accordance with an order of the difference of the failure rate.

6. The information processing device according to claim 1,
wherein the display displays the difference in the failure rate for each categorization of the apparatuses or equipment.

7. The information processing device according to claim 6,
wherein the display provides display in accordance with an order of the difference of the failure rate.

8. The information processing device according to claim 1,
wherein in a case where the failure rate of the first maintenance method is higher than the failure rate of the second maintenance method by a predetermined value or more, the display displays the second maintenance method in a highlighted manner.

9. The information processing device according to claim 1,
wherein in a case where an increase rate of the failure rate of the first maintenance method is higher than an increase rate of the failure rate of the second maintenance method by a predetermined value or more, the display displays the second maintenance method in a highlighted manner.

10. The information processing device according to claim 1,
wherein in a case where the difference in the failure rate is predetermined value or less, the display displays, among the first maintenance method and the second maintenance method, a maintenance method with a less cost, a lower frequency of maintenance, a less number of maintenance target items, or a shorter operation time, in a highlighted manner.
